(19) United States
(12) Patent Application Publication
(10) Pub. No.: US 2022/0213317 A1
(43) Pub. Date: Jul. 7, 2022

(54) Thermoplastic Resin Composition for Laser Direct Structuring Process, and Molded Product Comprising Same

(71) Applicant: LOTTE CHEMICAL CORPORATION, Seoul (KR)

(72) Inventors: Nam Hyun KIM, Uiwang-si (KR); Yang Il KIM, Uiwang-si (KR); Young Mi KIM, Uiwang-si (KR); Bong Jae LEE, Uiwang-si (KR); Sang Hwa LEE, Uiwang-si (KR)

(21) Appl. No.: 17/607,181

(22) PCT Filed: May 19, 2020
(86) PCT No.: PCT/KR2020/006556

§ 371 Date: Oct. 28, 2021

(30) Foreign Application Priority Data
May 31, 2019 (KR) 10-2019-0064402

(51) Int. Cl. C08L 69/00; C23C 18/20; C23C 18/16

(52) U.S. Cl. CPC C08L 69/00; C23C 18/1612; C23C 18/204

(57) ABSTRACT

A thermoplastic resin composition of the present invention comprises: approximately 100 parts by weight of a polycarbonate resin; approximately 1-10 parts by weight of an additive for laser direct structuring; approximately 0.1-7 parts by weight of a maleic anhydride-modified olefin-based copolymer; and approximately 0.1-4 parts by weight of a phosphite compound represented by chemical formula 1. The thermoplastic resin composition has excellent plating reliability, impact resistance, chemical resistance and the like, and generates a small amount of gas during injection molding, and thus has excellent injection stability.

### TECHNICAL FIELD

The present invention relates to a thermoplastic resin composition for laser direct structuring process and a molded product comprising the same. More specifically, the present invention relates to a thermoplastic resin composition for laser direct structuring process, which exhibits good properties in terms of plating reliability, impact resistance, chemical resistance and the like, and can secure good injection stability by suppressing generation of gas upon injection molding, and a molded product comprising the same.

### BACKGROUND ART

A laser direct structuring (LDS) process may be used to form a metal layer on at least part of a surface of a molded product produced from a thermoplastic resin composition. The LDS process is a pretreatment method to modify a plating target region on a surface of the molded product to have suitable properties for plating by irradiating the plating target region with laser beams. To this end, a thermoplastic resin composition is required to contain an additive for laser direct structuring (LDS additive), which can form metal nuclei upon irradiation with laser beams. The LDS additive is decomposed to generate metal nuclei upon irradiation with the laser beams. In addition, a region irradiated with laser beams has a roughened surface. Due to such metal nuclei and surface roughness, the laser-modified region becomes suitable for plating.

The LDS process allows rapid and economic formation of electronic/electric circuits on a three-dimensional molded product. For example, the LDS process may be advantageously used in manufacture of antennas for portable electronic devices, radio frequency identification (RFID) antennas, and the like.

In recent years, with increasing tendency of reduction in weight and thickness of portable device products, there is increasing demand for a thermoplastic resin composition which can exhibit excellent mechanical properties and molding processability (external appearance). In addition, there is a need for a post-injection plating process for preventing generation of daily life scratches while securing various colors, clear coating, or good external appearance. In this case, a coating solution and paints are diluted in various organic solvents and deposited on a surface of a product formed of a resin, followed by drying. However, the organic solvents used as diluents in this process enter the thermoplastic resin, causing deterioration in mechanical properties such as impact resistance and the like.

Moreover, as the thickness of fine patterns (plating region) of electric/electronic circuits, such as portable electronic devices and the like, becomes thinner, there can be a problem of deterioration in plating reliability through plating peeling and a typical LDS additive deteriorates thermal stability of the thermoplastic resin through decomposition of the thermoplastic resin at a processing temperature of the thermoplastic resin composition, thereby causing gas generation, discoloration, carbonization, and the like.

Therefore, there is a need for development of a thermoplastic resin composition for laser direct structuring process, which exhibits good properties in terms of plating reliability, impact resistance, chemical resistance (impact resistance after plating) and the like, and can secure good injection stability by suppressing generation of gas upon injection molding, and a molded product comprising the same.

The background technique of the present invention is disclosed in Korean Patent Laid-open Publication No. 2011-0018319.

### DISCLOSURE

### Technical Problem

It is one aspect of the present invention to provide a thermoplastic resin composition, which exhibits good properties in terms of plating reliability, impact resistance, chemical resistance and the like, and can secure good injection stability by suppressing generation of gas upon injection molding.

It is another aspect of the present invention to provide a molded product produced from the thermoplastic resin composition.

The above and other aspects of the present invention will be apparent from the detailed description of the invention.

### Technical Solution

1. One aspect of the present invention relates to a thermoplastic resin composition. The thermoplastic resin composition comprises: about 100 parts by weight of a polycarbonate resin; about 1 part by weight to about 10 parts by weight of an additive for laser direct structuring; about 0.1 parts by weight to about 7 parts by weight of a maleic anhydride-modified olefin copolymer; and about 0.1 parts by weight to about 4 parts by weight of a phosphite compound represented by Formula 1:

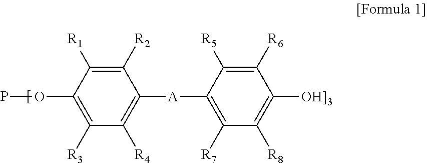

where R₁, R₂, R₃, R₄, R₅, R₆, R₇ and R₈ are each independently a hydrogen atom or a C₁ to C₁₀ alkyl group and A is a sulfur atom or an oxygen atom.

2. In Embodiment 1, the additive for laser direct structuring may comprise at least one of a heavy metal oxide composite spinel and a copper salt.

3. In Embodiment 1 or 2, the maleic anhydride-modified olefin copolymer may comprise a maleic anhydride-modified alkylene-α-olefin copolymer obtained through graft copolymerization of maleic anhydride to an alkylene-α-olefin copolymer.

4. In Embodiments 1 to 3, the maleic anhydride-modified olefin copolymer may comprise at least one of a maleic anhydride-modified ethylene-butane copolymer and a maleic anhydride-modified ethylene-octane copolymer.

5. In Embodiments 1 to 4, at least one of R₁, R₂, R₃, and R₄ may comprise a C₄ to C₁₀ branched alkyl group and at least one of R₅, R₆, R₇ and R₈ may comprise a C₄ to C₁₀ branched alkyl group.

6. In Embodiments 1 to 5, the phosphite compound may comprise a compound represented by Formula 1a.

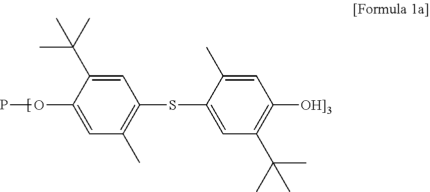

7. In Embodiments 1 to 6, the maleic anhydride-modified olefin copolymer and the phosphite compound may be present in a weight ratio of about 1.5:1 to about 30:1.

8. In Embodiments 1 to 7, the maleic anhydride-modified olefin copolymer and the phosphite compound may be present in a weight ratio of about 1:1.2 to about 1:15.

9. In Embodiments 1 to 8, the thermoplastic resin composition may have about 90 grid-lattices or more remaining without being peeled off when a tape is attached to and is then detached from an injection-molded specimen having a size of 50 mm×90 mm×3.2 mm after leaving the specimen at 25° C. for 6 hours, activating a surface of the specimen in stripe form through laser direct structuring process, forming a 35 μm thick copper layer on the activated surface of the specimen through plating (copper electroless plating) process, leaving the specimen in a chamber under conditions of 85° C. and 85% RH (relative humidity) for 120 hours, and carving 100 grid-lattices each having a size of 1 mm×1 mm on the plating layer (copper layer).

10. In Embodiments 1 to 9, the thermoplastic resin composition may have a notched Izod impact strength of about 65 kgf·cm/cm to about 90 kgf·cm/cm, as measured on a ⅛″ thick specimen in accordance with ASTM D256.

11. In Embodiments 1 to 10, the thermoplastic resin composition may have a fracture height of about 75 cm to about 110 cm, at which a specimen of the thermoplastic resin composition is fractured upon dropping a weight of 4 kg on the specimen in accordance with the DuPont drop test method, in which the specimen is prepared by dipping a 2 mm thick specimen in a thinner solution for 2.5 minutes, drying the specimen at 80° C. for 20 minutes, and leaving the specimen at room temperature for 24 hours.

12. Another aspect of the present invention relates to a molded product. The molded product may be formed of the thermoplastic resin composition according to any one of Embodiments 1 to 11.

13. In Embodiment 12, the molded product may comprise a metal layer formed on at least part of a surface thereof through a laser direct structuring process and a plating process.

### Advantageous Effects

The present invention provides a thermoplastic resin composition, which exhibits good properties in terms of plating reliability, impact resistance, chemical resistance and the like, and can secure good injection stability by suppressing generation of gas upon injection molding, and a molded product produced therefrom.

### DRAWINGS

FIG. 1 is a schematic sectional view of a molded product according to one embodiment of the present invention.

### BEST MODE

Hereinafter, embodiments of the present invention will be described in detail.

A thermoplastic resin composition according to the present invention is applicable to a laser direct structuring process (LDS process) and comprises: (A) a polycarbonate resin; (B) an additive for laser direct structuring (LDS additive); (C) a maleic anhydride-modified olefin copolymer; and (D) a phosphite compound.

As used herein to represent a specific numerical range, the expression “a to b” is defined as “a≤ and ≤b”.

(A) Polycarbonate Resin

The polycarbonate resin according to one embodiment of the present invention may be selected from among any polycarbonate resins used in typical thermoplastic resin compositions. For example, the polycarbonate resin may be an aromatic polycarbonate resin prepared by reacting diphenols (aromatic diol compounds) with a precursor, such as phosgene, halogen formate, or carbonate diester.

In one embodiment, the diphenols may comprise, for example, 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, and 2,2-bis-(3,5-dichloro-4-hydroxyphenyl)propane, without being limited thereto. For example, the diphenols may be 2,2-bis(4-hydroxyphenyl)propane, 2,2-bis(3,5-dichloro-4-hydroxyphenyl)propane, or 1,1-bis(4-hydroxyphenyl)cyclohexane, specifically 2,2-bis(4-hydroxyphenyl)propane, which is also referred to as bisphenol-A.

In one embodiment, the polycarbonate resin may be a branched polycarbonate resin. For example, the polycarbonate resin may be a polycarbonate resin prepared by adding a tri- or higher polyfunctional compound, specifically, a tri- or higher valent phenol group-containing compound, in an amount of about 0.05 mol % to about 2 mol % based on the total number of moles of the diphenols used in polymerization.

In one embodiment, the polycarbonate resin may be a homopolycarbonate resin, a copolycarbonate resin, or a blend thereof. In addition, the polycarbonate resin may be partly or completely replaced by an aromatic polyester-carbonate resin obtained by polymerization in the presence of an ester precursor, for example, a bifunctional carboxylic acid.

In one embodiment, the polycarbonate resin may have a weight average molecular weight (Mw) of about 10,000 g/mol to about 200,000 g/mol, for example, about 15,000 g/mol to about 80,000 g/mol, as measured by gel permeation chromatography (GPC). Within this range, the thermoplastic resin composition can have good fluidity (processability).

(B) Additive for Laser Direct Structuring

According to one embodiment of the present invention, the LDS additive serves to form metal nuclei upon irradiation with laser beams and may comprise any typical LDS additive used in resin compositions for LDS. Here, the laser beam means light amplified through simulated emission (simulated emission light) and may be UV light having a wavelength of about 100 nm to about 400 nm, visible light having a wavelength of about 400 nm to about 800 nm, or infrared (IR) light having a wavelength of about 800 nm to about 25,000 nm, for example, IR light having a wavelength of about 1,000 nm to about 2,000 nm.

In one embodiment, the LDS additive may comprise at least one of a heavy metal composite oxide spinel and/or a copper salt.

In one embodiment, the heavy metal composite oxide spinel may be represented by Formula 2.

AB₂O₄ [Formula 2]

In Formula 2, A is a metal cation having a valence of 2, for example, magnesium, copper, cobalt, zinc, tin, iron, manganese, nickel, and a combination thereof, and B is a metal cation having a valence of 3, for example, manganese, nickel, copper, cobalt, tin, titanium, iron, aluminum, chromium, and a combination thereof.

In the heavy metal composite oxide spinel represented by Formula 2, A provides a monovalent cation component of a metal oxide cluster and B provides a monovalent cation component of a metal cation cluster. For example, the metal oxide cluster comprising A may have a tetrahedral structure and the metal oxide cluster comprising B may have an octahedral structure. Specifically, the heavy metal complex oxide spinel represented by Formula 2 may have a structure in which oxygen atoms are arranged in a cubic close-packed lattice, and B and A occupy octahedral and tetrahedral sites in the lattice, respectively.

In one embodiment, the heavy metal composite oxide spinel may comprise magnesium aluminum oxide (MgAl₂O₄), zinc aluminum oxide (ZnAl₂O₄), iron aluminum oxide (FeAl₂O₄), copper iron oxide (CuFe₂O₄), copper chromium oxide (CuCr₂O₄), manganese iron oxide (MnFe₂O₄), nickel iron oxide (NiFe₂O₄), titanium iron oxide (TiFe₂O₄), iron chromium oxide (FeCr₂O₄), magnesium chromium oxide (MgCr₂O₄), and combinations thereof. For example, the heavy metal complex oxide may be copper chromium oxide (CuCr₂O₄). The copper chromium oxide (CuCr₂O₄) has a dark color and thus is advantageous when a final molded product is required to be black or grey.

In one embodiment, the copper salt may comprise copper hydroxide phosphate, copper phosphate, copper sulfate, cuprous thiocyanate, and combinations thereof, without being limited thereto. For example, the copper salt may be copper hydroxide phosphate. The copper hydroxide phosphate is a compound in which copper phosphate is combined with copper hydroxide, and may comprise Cu₃(PO₄)₂.2Cu(OH)₂, Cu₃(PO₄)₂.Cu(OH)₂, and the like. The copper hydroxide phosphate does not affect color-reproduction properties of a colorant, as an additive, and thus allows a molded product having a desired color to be easily obtained.

In one embodiment, the LDS additive may have an average particle diameter of about 0.01 μm to about 50 μm, for example, about 0.1 μm to about 30 μm, specifically about 0.5 μm to about 10 μm. Within this range, the LDS additive enables formation of a uniform coating surface through laser direct structuring.

As used herein, unless otherwise specifically stated, the term “average particle diameter” refers to D50 (a diameter at a distribution rate of 50%) which is a number average particle diameter.

In one embodiment, the LDS additive may be present in an amount of about 1 to about 10 parts by weight, for example, about 2 to about 7 parts by weight, relative to about 100 parts by weight of the polycarbonate resin. If the content of the LDS additive is less than about 1 part by weight relative to about 100 parts by weight of the polycarbonate resin, a sufficient amount of metal nuclei is not formed in the coating during irradiation of the thermoplastic resin composition (molded product) with laser beams, thereby causing deterioration in plating adhesion, and if the content of the LDS additive exceeds about 10 parts by weight, the thermoplastic resin composition can suffer from deterioration in impact resistance and heat resistance.

(C) Maleic Anhydride-Modified Olefin Copolymer

The maleic anhydride-modified olefin copolymer according to one embodiment of the present invention is a reactive type olefin copolymer obtained through graft copolymerization of a reactive functional group, for example, maleic anhydride, to an olefin copolymer, and can improve plating reliability, impact resistance, chemical resistance, and injection stability of the thermoplastic resin composition together with a particular phosphite compound.

In one embodiment, the maleic anhydride-modified olefin copolymer may be obtained through graft copolymerization of maleic anhydride to an olefin copolymer obtained through copolymerization of at least two alkylene monomers. The alkylene monomer may be a C₂ to C₁₀ alkylene and may be selected from among, for example, ethylene, propylene, isopropylene, butylene, isobutylene, octane, and combinations thereof.

In one embodiment, the maleic anhydride-modified olefin copolymer may comprise a maleic anhydride-modified alkylene-α-olefin copolymer obtained through graft copolymerization of maleic anhydride to an alkylene-α-olefin copolymer.

In one embodiment, the maleic anhydride-modified olefin copolymer may comprise a maleic anhydride-modified ethylene-butane copolymer, a maleic anhydride-modified ethylene-octane copolymer, and a combination thereof.

In one embodiment, the maleic anhydride-modified olefin copolymer may have a melt-flow index of about 0.5 g/10 min to about 20 g/10 min, for example, about 1 g/10 min to about 10 g/10 min, as measured under conditions of 190° C. and a load of 2.16 kg in accordance with ASTM D1238.

In one embodiment, the maleic anhydride-modified olefin copolymer may be present in an amount of about 0.1 parts by weight to about 7 parts by weight, for example, about 0.2 parts by weight to about 5 parts by weight, relative to about 100 parts by weight of the polycarbonate resin. If the content of the maleic anhydride-modified olefin copolymer is less than about 0.1 parts by weight relative to about 100 parts by weight of the polycarbonate resin, the thermoplastic resin composition can suffer from deterioration in plating reliability, chemical resistance, and the like, and if the content of the maleic anhydride-modified olefin copolymer exceeds about 7 parts by weight, the thermoplastic resin composition can suffer from deterioration in chemical resistance, impact resistance, injection stability, and the like.

(D) Phosphite Compound

The phosphite compound according to the present invention serves to improve plating reliability, impact resistance, chemical resistance, and injection stability of the thermoplastic resin composition together with the maleic anhydride-modified olefin copolymer and may comprise a phosphite compound represented by Formula 1.

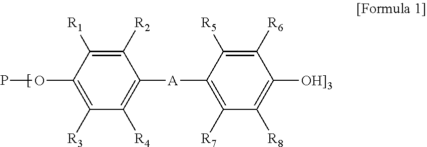

In Formula 1, R₁, R₂, R₃, R₄, R₅, R₆, R₇ and R₈ are each independently a hydrogen atom or a C₁ to C₁₀ alkyl group, and A is a sulfur atom or an oxygen atom.

In one embodiment, at least one of R₁, R₂, R₃ and R₄ may comprise a C₄ to C₁₀ branched alkyl group and at least one of R₅, R₆, R₇ and R₈ may comprise a C₄ to C₁₀ branched alkyl group.

In one embodiment, the phosphite compound may comprise a compound represented by Formula 1a.

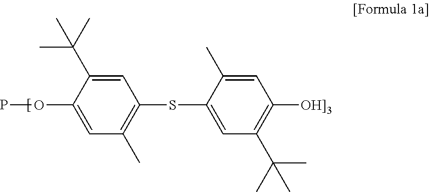

In one embodiment, the phosphite compound may be present in an amount of about 0.1 parts by weight to about 4 parts by weight, for example, about 0.2 parts by weight to about 2 parts by weight, relative to about 100 parts by weight of the polycarbonate resin. If the content of the phosphite compound is less than about 0.1 parts by weight relative to about 100 parts by weight of the polycarbonate resin, the thermoplastic resin composition can suffer from deterioration in plating reliability, chemical resistance, and the like, and if the content of the phosphite compound exceeds about 4 parts by weight, the thermoplastic resin composition can suffer from deterioration in chemical resistance, impact resistance, injection stability, and the like.

In one embodiment, the maleic anhydride-modified olefin copolymer (C) and the phosphite compound (D) may be present in a weight ratio (C:D) of about 1.5:1 to about 30:1, for example, about 2:1 to about 25:1. Within this range, the thermoplastic resin composition can exhibit good properties in terms of plating reliability, chemical resistance, injection stability, and the like.

In another embodiment, the maleic anhydride-modified olefin copolymer (C) and the phosphite compound (D) may be present in a weight ratio (C:D) of about 1:1.2 to about 1:15, for example, about 1:1.5 to about 1:10. Within this range, the thermoplastic resin composition can exhibit good properties in terms of plating reliability, chemical resistance, injection stability, and the like.

In one embodiment, the thermoplastic resin composition may further comprise any additives commonly used in typical thermoplastic resin compositions. Examples of the additives may comprise flame retardants, anti-dripping agents, inorganic fillers, lubricants, nucleating agents, stabilizers, release agents, pigments, dyes, and mixtures thereof, without being limited thereto. The additives may be present in an amount of about 0.001 parts by weight to about 40 parts by weight, for example, about 0.1 parts by weight to about 10 parts by weight, relative to about 100 parts by weight of the polycarbonate resin.

According to one embodiment, the thermoplastic resin composition may be prepared in pellet form by mixing the above components, followed by melt extrusion of the mixture in a typical twin-screw extruder at about 200° C. to about 280° C., for example, about 220° C. to about 260° C.

In one embodiment, the thermoplastic resin composition may have about 90 grid-lattices or more, for example, about 90 to 97 grid-lattices, remaining without being peeled off when a tape is attached to and is then detached from an injection-molded specimen having a size of 50 mm×90 mm×3.2 mm after leaving the specimen at 25° C. for 6 hours, activating a surface of the specimen in stripe form through laser direct structuring process, forming a 35 μm thick copper layer on the activated surface of the specimen through plating (copper electroless plating) process, leaving the specimen in a chamber under conditions of 85° C. and 85% RH for 120 hours, and carving 100 grid-lattices each having a size of 1 mm×1 mm on the plating layer (copper layer).

In one embodiment, the thermoplastic resin composition may have a notched Izod impact strength of about 65 kgf·cm/cm to about 90 kgf·cm/cm, for example, about 65 kgf·cm/cm to about 80 kgf·cm/cm, as measured on a ⅛″ thick specimen in accordance with ASTM D256.

In one embodiment, the thermoplastic resin composition may have a fracture height of about 75 cm to about 110 cm, for example, about 80 cm to about 105 cm, at which a specimen of the thermoplastic resin composition is fractured upon dropping a weight of 4 kg on the specimen in accordance with the DuPont drop test method, in which the specimen is prepared by dipping a 2 mm thick specimen in a thinner solution for 2.5 minutes, drying the specimen at 80° C. for 20 minutes, and leaving the specimen at room temperature for 24 hours.

A molded product according to the present invention is formed of the thermoplastic resin composition as set forth above. For example, the molded product may be prepared by any suitable molding method, such as injection molding, compression molding, blow molding, extrusion molding, and the like, using the thermoplastic resin composition. The molded product can be easily formed by those skilled in the art.

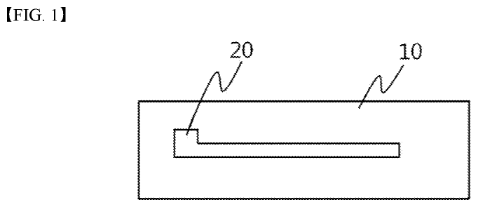

FIG. 1 is a schematic sectional view of a molded product according to one embodiment of the present invention. It should be noted that the drawing is exaggerated in thickness of lines or size of components for descriptive convenience and clarity only. Referring to FIG. 1, a molded product 10 according to this embodiment may comprise a metal layer 20 formed on at least part of a surface thereof through LDS and plating. The molded product 10 according to the embodiment may be a circuit carrier used in manufacture of antennas. For example, the molded product 10 may be manufactured by preparing a preform 10 through injection molding of the thermoplastic resin composition and irradiating a specific region (a portion to be formed with the metal layer 20) on the surface of the preform 10 with laser beams, followed by metallization (plating) of the irradiated region to form the metal layer 20.

In this embodiment, the LDS additive comprised in the preform 10 is decomposed to form metal nuclei upon irradiation with laser beams. In addition, the laser beam-irradiated region has a suitable surface roughness for plating. Here, the laser beams may have a wavelength of about 248 nm, about 308 nm, about 355 nm, about 532 nm, about 1,064 nm, or about 10,600 nm.

In this embodiment, metallization may be performed by any typical plating process. For example, metallization may comprise dipping the laser beam-irradiated preform 10 in at least one electroless plating bath to form the metal layer 20 (electrically conductive path) on the laser beam-irradiated region of the surface of the preform 10. Here, examples of electroless plating may comprise copper plating, gold plating, nickel plating, silver plating, zinc plating, and tin plating.

The molded product having the metal layer on at least part of the surface thereof by LDS can be easily manufactured by those skilled in the art.

### Mode for Invention

Next, the present invention will be described in more detail with reference to some examples. It should be understood that these examples are provided for illustration only and are not to be in any way construed as limiting the present invention.

### Example

Details of components used in Examples and Comparative Examples are as follows.

(A) Polycarbonate Resin

A bisphenol-A type polycarbonate resin having a weight average molecular weight (Mw) of 25,000 g/mol was used.

(B) Additive for Laser Direct Structuring

Copper hydroxide phosphate (Manufacturer: Merck Performance Materials Co., Ltd.) was used.

(C) Modified Olefin Copolymer

(C1) A maleic anhydride-modified ethylene-butane copolymer (Manufacturer: Mitsui Chemicals Co., Ltd.) was used.

(C2) A glycidyl methacrylate-modified ethylene-butyl acrylate copolymer (Manufacturer: DuPont) was used.

(D) Phosphite Compound

(D1) A phosphite compound represented by Formula 1a was used.

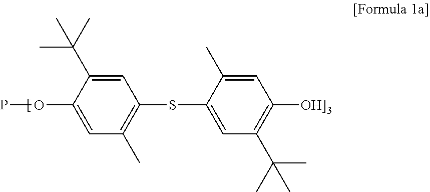

(D2) A triphenyl phosphite compound was used.

(D3) A tri(2,4-di-tert-butylphenyl) phosphite compound was used.

(D4) A tris(4-methoxy phenyl) phosphite compound was used.

### Examples 1 to 7 and Comparative Examples 1 to 8

The above components were weighed in amounts as listed in Tables 1 and 2 and subjected to extrusion at 250° C., thereby preparing thermoplastic resin compositions in pellet form. Extrusion was performed using a twin-screw extruder (L/D=36, Φ45 mm) and the prepared pellets were dried at 100° C. for 4 hours or more and subjected to injection molding using a 10 oz injection molding machine (injection temperature: 300° C.), thereby preparing specimens. The prepared specimens were evaluated as to the following properties by the following methods and evaluation results are shown in Tables 1 and 2.

Property Evaluation

(1) Plating reliability: An injection-molded specimen having a size of 50 mm×90 mm×3.2 mm was left at 25° C. for 6 hours, followed by activating a surface of the specimen in stripe form through laser direct structuring process. Then, a 35 μm thick copper layer was formed on the activated surface of the specimen through plating (copper electroless plating) process and left in a chamber under conditions of 85° C. and 85% RH for 120 hours, followed by carving 100 grid-lattices each having a size of 1 mm×1 mm on the plating layer (copper layer), followed by counting the number of grid-lattices remaining on the plating layer upon detachment of a tape from the plating layer.

(2) Notched Izod impact resistance (kgf·cm/cm): Notched Izod impact strength was measured on a ⅛″ thick specimen in accordance with ASTM D256.

(3): Chemical resistance (impact resistance after plating): An injection molded specimen having a size of 50 mm×200 mm×2 mm was dipped in a thinner solution for 2.5 minutes, dried at 80° C. for 20 minutes, and left at room temperature for 24 hours, followed by measuring a fracture height (unit: cm), at which the specimen was fractured upon dropping a weight of 4 kg on the specimen in accordance with the DuPont drop test method.

(4) Injection stability: 10 specimens each having a size of 50 mm×200 mm×2 mm were prepared through continuous injection molding, followed by counting the number of specimens generating gas silver streaks around a gate of the specimen.

TABLE 1

| | Example | | | | | | |
|---|---|---|---|---|---|---|---|
| | 1 | 2 | 3 | 4 | 5 | 6 | 7 |
| (A) (parts by weight) | 100 | 100 | 100 | 100 | 100 | 100 | 100 |
| (B) (parts by weight) | 4 | 4 | 4 | 4 | 4 | 2 | 7 |
| (C1) (parts by weight) | 0.2 | 5 | 0.2 | 5 | 2.5 | 0.2 | 5 |
| (C2) (parts by weight) | — | — | — | — | — | — | — |
| (D1) (parts by weight) | 0.3 | 0.2 | 2 | 2 | 1.1 | 0.3 | 2 |
| (D2) (parts by weight) | — | — | — | — | — | — | — |
| (D3) (parts by weight) | — | — | — | — | — | — | — |
| (D4) (parts by weight) | — | — | — | — | — | — | — |
| Plating reliability | 93 | 96 | 95 | 94 | 97 | 91 | 90 |
| Notched Izod Impact | 70 | 70 | 70 | 72 | 75 | 79 | 66 |
| strength (kgf · cm/cm) | | | | | | | |
| Fracture height (cm) | 82 | 105 | 85 | 102 | 92 | 86 | 77 |
| Number of specimens | 0 | 0 | 0 | 0 | 0 | 0 | 0 |
| generating silver | | | | | | | |
| streaks (Number) | | | | | | | |

TABLE 2

| | Comparative Example | | | | | | | |
|---|---|---|---|---|---|---|---|---|
| | 1 | 2 | 3 | 4 | 5 | 6 | 7 | 8 |
| (A) (parts by weight) | 100 | 100 | 100 | 100 | 100 | 100 | 100 | 100 |
| (B) (parts by weight) | 4 | 4 | 4 | 4 | 4 | 4 | 4 | 4 |
| (C1) (parts by weight) | 0.05 | 9 | — | 2.5 | 2.5 | 2.5 | 2.5 | 2.5 |
| (C2) (parts by weight) | — | — | 2.5 | — | — | — | — | — |
| (D1) (parts by weight) | 1.1 | 1.1 | 1.1 | 0.05 | 5 | — | — | — |
| (D2) (parts by weight) | — | — | — | — | — | 1.1 | — | — |
| (D3) (parts by weight) | — | — | — | — | — | — | 1.1 | — |
| (D4) (parts by weight) | — | — | — | — | — | — | — | 1.1 |
| Plating reliability | 86 | 91 | 77 | 80 | 93 | 79 | 75 | 80 |
| Notched Izod Impact | 70 | 58 | 70 | 72 | 59 | 70 | 71 | 70 |
| strength (kgf · cm/cm) | | | | | | | | |
| Fracture height (cm) | 65 | 104 | 62 | 70 | 45 | 69 | 72 | 68 |
| Number of specimens | 0 | 5 | 0 | 0 | 3 | 0 | 0 | 0 |
| generating silver | | | | | | | | |
| streaks (Number) | | | | | | | | |

From the result, it can be seen that the thermoplastic resin composition according to the present invention has good properties in terms of plating reliability, impact resistance, chemical resistance (impact resistance after plating), and the like, and secures good injection stability by suppressing gas generation upon injection molding.

On the contrary, it could be seen that the resin composition of Comparative Example 1 prepared using an insufficient amount of the maleic anhydride-modified olefin copolymer suffered from deterioration in plating reliability, chemical resistance, and the like; the resin composition of Comparative Example 2 prepared using an excess of the maleic anhydride-modified olefin copolymer suffered from deterioration in impact resistance, injection stability, and the like; and the resin composition of Comparative Example 3 prepared using the glycidyl methacrylate modified ethylene-butyl acrylate copolymer (C2) instead of the maleic anhydride-modified olefin copolymer suffered from deterioration in plating reliability, chemical resistance, and the like. It could be seen that the resin composition of Comparative Example 4 prepared using an insufficient amount of the phosphite compound suffered from deterioration in plating reliability, chemical resistance, and the like; the resin composition of Comparative Example 5 prepared using an excess of the phosphite compound suffered from deterioration in impact resistance, chemical resistance, injection stability, and the like; and the resin compositions of Comparative Examples 6 to 8 prepared using the phosphite compounds (D2), (D3) and (D4), respectively, instead of the phosphite compound according to the present invention suffered from deterioration in plating reliability, chemical resistance, and the like.

It should be understood that various modifications, changes, alterations, and equivalent embodiments can be made by those skilled in the art without departing from the spirit and scope of the present invention.

1. A thermoplastic resin composition comprising:
about 100 parts by weight of a polycarbonate resin;
about 1 part by weight to about 10 parts by weight of an additive for laser direct structuring;
about 0.1 parts by weight to about 7 parts by weight of a maleic anhydride-modified olefin copolymer; and
about 0.1 parts by weight to about 4 parts by weight of a phosphite compound represented by Formula 1: 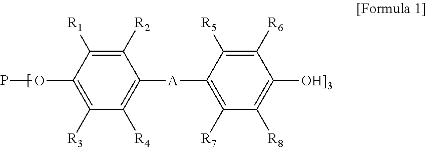
where R₁, R₂, R₃, R₄, R₅, R₆, R₇ and R₈ are each independently a hydrogen atom or a C₁ to C₁₀ alkyl group and A is a sulfur atom or an oxygen atom.

2. The thermoplastic resin composition according to claim 1, wherein the additive for laser direct structuring comprises a heavy metal oxide composite spinel and/or a copper salt.

3. The thermoplastic resin composition according to claim 1, wherein the maleic anhydride-modified olefin copolymer comprises a maleic anhydride-modified alkylene-α-olefin copolymer obtained through graft copolymerization of maleic anhydride to an alkylene-α-olefin copolymer.

4. The thermoplastic resin composition according to claim 1, wherein the maleic anhydride-modified olefin copolymer comprises a maleic anhydride-modified ethylene-butane copolymer and/or a maleic anhydride-modified ethylene-octane copolymer.

5. The thermoplastic resin composition according to claim 1, wherein one or more of R₁, R₂, R₃ and R₄ comprises a C₄ to C₁₀ branched alkyl group and one or more of R₅, R₆, R₇ and R₈ comprises a C₄ to C₁₀ branched alkyl group.

6. The thermoplastic resin composition according to claim 1, wherein the phosphite compound comprises a compound represented by Formula 1a:

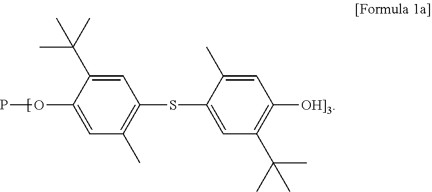

7. The thermoplastic resin composition according to claim 1, wherein the maleic anhydride-modified olefin copolymer and the phosphite compound are present in a weight ratio of about 1.5:1 to about 30:1.

8. The thermoplastic resin composition according to claim 1, wherein the maleic anhydride-modified olefin copolymer and the phosphite compound are present in a weight ratio of about 1:1.2 to about 1:15.

9. The thermoplastic resin composition according to claim 1, wherein the thermoplastic resin composition has about 90 grid-lattices or more remaining without being peeled off when a tape is attached to and is then detached from an injection-molded specimen having a size of 50 mm×90 mm×3.2 mm after leaving the specimen at 25° C. for 6 hours, activating a surface of the specimen in stripe form through laser direct structuring, forming a 35 μm thick copper layer on the activated surface of the specimen through plating (copper electroless plating), leaving the specimen in a chamber under conditions of 85° C. and 85% RH for 120 hours, and carving 100 grid-lattices each having a size of 1 mm×1 mm on the plating layer (copper layer).

10. The thermoplastic resin composition according to claim 1, wherein the thermoplastic resin composition has a notched Izod impact strength of about 65 kgf·cm/cm to about 90 kgf·cm/cm, as measured on a ⅛″ thick specimen in accordance with ASTM D256.

11. The thermoplastic resin composition according to claim 1, wherein the thermoplastic resin composition has a fracture height of about 75 cm to about 110 cm, at which a specimen of the thermoplastic resin composition is fractured upon dropping a weight of 4 kg on the specimen in accordance with the DuPont drop test method, in which the specimen is prepared by dipping a 2 mm thick specimen in a thinner solution for 2.5 minutes, drying the specimen at 80° C. for 20 minutes, and leaving the specimen at room temperature for 24 hours.

12. A molded product formed of the thermoplastic resin composition according to claim 1.

13. The molded product according to claim 12, wherein the molded product comprises a metal layer formed on at least part of a surface thereof through a laser direct structuring process and a plating process.
